(19) United States
(12) Patent Application Publication
(10) Pub. No.: US 2006/0248171 A1
(43) Pub. Date: Nov. 2, 2006

(54) Method for adapting software

(75) Inventors: Werner Herla, Hochstadt (DE); Martin Kiesel, Poxdorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munich (DE)

(21) Appl. No.: 10/556,159

(22) PCT Filed: Apr. 22, 2004
(86) PCT No.: PCT/EP04/04290

§ 371 Date: Nov. 8, 2005

(30) Foreign Application Priority Data
May 8, 2003 (DE) 103 20 827.5

(51) Int. Cl. G06F 15/177

(52) U.S. Cl. 709/220

(57) ABSTRACT

The invention relates to a method for adapting hardware-dependent software to hardware, which improves the adaptation of the hardware-dependent software to a new hardware configuration. The software, in particular a binary image, can be executed in hardware that constitutes an automation device. A configuration of the hardware is stored in the software. According to said method, during the runup of the software in the automation device, the configuration of the hardware is identified and compared with the first stored configuration. If a different configuration is identified, the software is modified by the use of adaptation information, in such a way that the software can be executed in the automation device with a different configuration.

### CROSS REFERENCE TO RELATED APPLICATIONS

This application claims priority to the German application No. 10320827.5, filed May 8, 2003 and to the International Application No. PCT/EP2004/004290, filed Apr. 22, 2004 which are incorporated by reference herein in their entirety.

### FIELD OF INVENTION

The invention relates to a method for adapting hardware-dependent software which can be executed on an automation system implemented by hardware.

### BACKGROUND OF INVENTION

If software is installed on an automation device it is possible to create a binary image of this software. With the aid of this binary image, which is stored on a removable data medium for example, the software can be backed up onto the same automation device or onto a further identical automation device. In particular this is a way of making it possible to restore a software state on an automation device. If the hardware of an automation device is different from the hardware on which the software of which a binary image was created can be executed, this binary image cannot be run on the automation device with chan ged hardware if the software involved is hardware-dependent software. The result of this is that the software has to be reinstalled on the automation device with changed hardware.

### SUMMARY OF INVENTION

The disadvantage here is that a large amount of time is required for reinstallation and that, if the software is reinstalled, data in particular which is stored after the installation of the software in this software and is present in the backup or in the binary image of this software is now no longer available because the software has been newly installed on the automation device with a changed hardware configuration. Additional data stored in the software is password settings or also configuration settings for example

The problem discussed here applies especially to PC-based automation devices. PC-based automation devices for example feature specific PC cards which require driver software. When such cards, for example a graphics card, an I/O card for inputs and outputs etc. is replaced, a new driver is necessary if the hardware of the new card used in the PC-based automation system differs from the previous card used. This problem is typical of PC-based platforms for an automation device since there are frequent technical changes in this area. Thus for example a new graphics chip on a new graphics card also requires a new driver, which is not present in the binary image of the executable software.

When replacing hardware of an automation device it has for example previously been necessary for each type of a hardware platform to maintain or to administer hardware-specific images, i.e. binary images. A further option is the at least part reinstallation or complete reinstallation of software. Both variants require considerable logistical outlay and take a great deal of time.

An object of the present invention is to specify a method or a corresponding automation device which improves the adaptation of hardware-dependent software to a new hardware configuration.

In accordance with the invention, this object is achieved by a method for adapting hardware-dependent software which is especially a binary image and which can be executed on an automation device implemented by hardware, with a configuration of the hardware being stored in the software and with the configuration of the hardware being detected as from the point at which the software starts up on the automation device, and being compared with the first stored configuration, whereafter, on detection of a different configuration, the software is modified by using adaptation information such that the software is able to be executed on the automation device with a different configuration.

Examples of automation devices are programmable logic controllers, PC-based open-loop or closed-loop controllers, motion controllers, open-loop and closed loop movement controllers, power converters with integrated open-loop or closed-loop controllers, devices for operation and monitoring etc.

This method enables the binary image, i.e. the image of software which is tailored to a specific configuration of the hardware of a first automation device, to be used on an automation device with hardware which differs from that of the first automation device, since it is adapted by the software to this hardware. The image copied onto the automation device with different hardware recognizes that the hardware is different. If the automation device on which the software can be executed features a specific type of hardware configuration, this configuration type is stored in the software. If execution of the software is now to be started on an automation device with a hardware configuration of a different type, the software establishes that this is a different type of hardware. The software establishes the hardware type for example on runup by detecting identifiers of the hardware, with the identifiers being able to be determined from the data of a BIOS for example.

In an advantageous embodiment the configuration of the hardware of the automation device is also stored in the software which can be executed on the hardware. The software is advantageously executed in such a way that it automatically determines or recognizes and stores the hardware configuration on which it is executing. If a binary image of this software is now created, this binary image features information ab out the hardware platform or the hardware on which the software can or could be executed, with this being especially advantageous for hardware-dependent software.

A further advantage of the present invention lies in the fact that the software, especially after the comparison of the configuration of the hardware, generates a request for provision of the adaptation information. To this end the software is trained to compare the stored information about the configuration of the hardware of the automation system on which the software can or could be executed with the configuration or the hardware platform of the automation system on which the software is currently located. If the software detects by this comparison a difference in the configurations, a request for provision of adaptation information is generated. Adaptation information is typically missing drivers for hardware components, which are then installed for example For a migration of the hardware configuration from a first hardware configuration to a further hardware configuration the adaptation information especially also contains delta information relating to the different hardware components used. The adaptation information is especially provided by suppliers or manufacturers of the hardware of the automation device or by the manufacturer of the hardware-platform of the automation device.

The adaptation information especially also features information about which change is necessary to the software, which is especially a binary image, in order for the software of a first known hardware configuration of the automation device to be successfully executed on a further known possible hardware configuration of the automation device. If the hardware of an automation device features different hardware components and if predetermined requirements of the hardware components are known, adaptation information modified in this respect can also be predefined and supplied by a manufacturer of the hardware platform.

A further advantage of the invention lies in the fact that the software automatically looks for the adaptation information or automatically accesses the adaptation information. The search for or access to the information is undertaken for example on at least one removable data medium connected to the automation device. The adaptation of the software to the new hardware configuration is undertaken automatically by the software. The software is thus adapted without any explicit user intervention. The adaptation information can also be accessed via a communication device such as a bus, an Ethernet, an Intranet or an Internet for example. The software itself or the adaptation information is trained to perform the automatic adaptation of the software,

A further advantage of the present invention thus lies in the fact that a binary image is created by the software which can be executed on a first automation device, whereafter the binary image is transferred to a further automation device, after which the software runs up on this device. This means that re-installations of software to obtain executable software on an automation device are no longer absolutely necessary. With a binary image of executable software and additional adaptation information automation devices which differ in a known way with regard to their hardware can be quickly equipped with executable software.

A further advantage of the present invention lies in the fact that with the software, especially as a binary image, static data and/or dynamic data are able to be transmitted or are transmitted from a first automation device to a further automation device. This enables parameter settings in particular to be transferred, for open-loop or closed-loop control of one or more automation devices for example, without it being necessary for the entire hardware of the automation devices to be identical. Parameter settings are an example of dynamic data. Dynamic data is data which is produced especially during the run time of the system, regardless of whether it is desired or undesired. This dynamic data can often not be extracted separately and cannot be transmitted to new hardware separately from static data which is not changed during the runtime of the software. In an image however both the dynamic data and also the static data are present and then also transmi tted as an image to the other hardware. If, when a component is to be replaced, a replacement component of the automation device differs in its hardware from the component to be replaced and if this difference relates to the software, in accordance with the invention the binary image can be used in connection with the adaptation information so that neither static nor dynamic data is lost.

An automation device for executing the method in accordance with the invention features especially a data memory for storing the software. A binary image or adaptation information is for example able to be stored on a removable data medium. Removable data media are for example a hard disk, a multimedia card (MMC), a CF card, a memory stick, a USB stick, etc.

In a further advantageous embodiment the binary image or the adaptation information can be transmitted via a communication device which the automation device in particular features. The communication device is for example a wired communication device or a wireless connection. Examples are as follows: Canbus, PROFIBUS, Ethernet, Internet, Intranet, W-LAN, serial bus, etc.

The automation device can especially be provided for a machine tool or a production machine or for an automatic handling machine. These types of automatic systems or machines are typical examples for the area of application of an automation device. Furthermore, especially with such machines or automatic systems, there is the possibility that the possible changes to the hardware platform or to the hardware of the automation devices are always known to an upgrader for automation devices provided for this purpose and they can therefore easily provide adaptation information. This is especially of advantage if the automation device is a PC-based automation device. In the area of PC-based automation devices, the fact that the devices are PC-based provides a very wide variety of opportunities for replacement of hardware components such as graphics cards, main boards, I/O cards for example. The person equipping the automation device or the manufacturer can select specific configurations of the hardware or the hardware platform of the automation device, so that only a restricted range of different hardware platforms or replacement options is specified and adaptation information, that is delta information of a configuration of the hardware, can be provided for the next configuration of the hardware.

Changes to the hardware platform or the configuration of the hardware of an automation device are for example triggered by: Upgrades to the automation device, replacement of defective components of the automation device, duplication of the software on different automation devices with different hardware configuration, etc.

### BRIEF DESCRIPTION OF THE DRAWINGS

Exemplary embodiments of the invention are shown in the drawing and are explained below. The Figures show:

FIG. 1 a first example of using the method in accordance with the invention,

FIG. 2 an example of the prior art, and

FIG. 3 a second example of using the method in accordance with the invention.

### DETAILED DESCRIPTION OF INVENTION

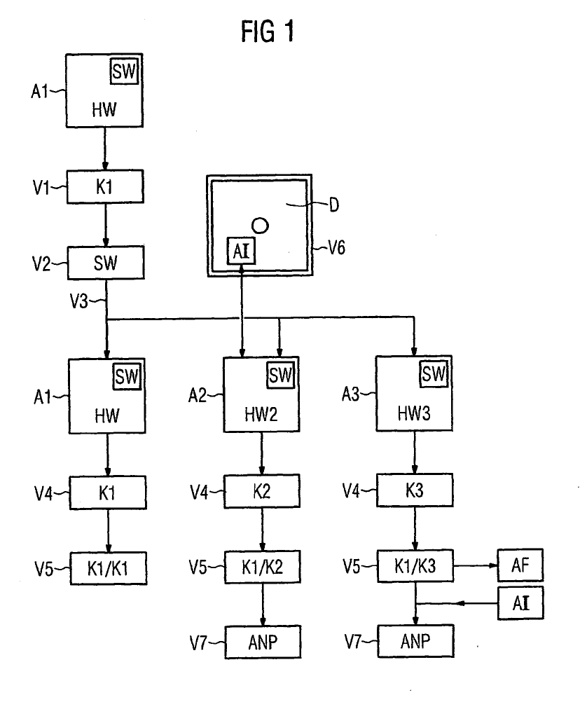

The diagram in FIG. 1 shows an automation device A1 which is implemented by hardware HW and on which hardware-dependent software SW can be executed. In a step V1 the software SW detects a configuration K1 of the hardware HW. In a further step V2 the information about the configuration K1 is stored in the software SW. In a further step V3 the software SW, which can be executed on the automation system A1, especially as a binary image of the software SW of the automation device A1, is transferred as a copy onto at least one of the automation devices A1, A2 to A3.

If the software SW is copied onto the original automation device A1, the software SW detects in a step V4 the configuration K1 of the hardware HW of the automation device A1. In a step V5 the software SW compares the original information stored in the software SW about the configuration K1 which was present in step V3 in the software with the configurations K1 of the hardware HW determined in step V4 and establishes that the configurations K1, K2 are the same, so that no further adaptations of the software SW to the configuration K1 of the hardware HW are to be undertaken.

If at least one component of the hardware HW of the automation device A1 has been replaced, with the replacement hardware component differing from the original hardware component, the automation device A1 produces a changed automation device A2 with changed hardware HW2 to which the software SW is transmitted in step V3. In a step V4 the software SW detects the new configuration K2. In a step V5 the fact that the configurations K1 or K2 are different is detected. In a step V6 the automation device A2 automatically fetches the adaptation information A1, for example from a diskette D to which the automation device A2 has access. Then in step V7 an adaptation ANP of the software SW is performed.

In step V3 the software SW can also be transmitted to an automation device A3 which features hardware HW3. In a step V4 the configuration K3 of the hardware HW3 is detected. In step V5 the difference between the stored configuration K1 and the newly recognized configuration K3 is detected and a request AF for provision of adaptation information A1 is output. After copying in of the adaptation information A1 an adaptation ANP is undertaken in step V7 so that the software SW which could be executed on the automation device A1 can now also be executed on the automation device A3.

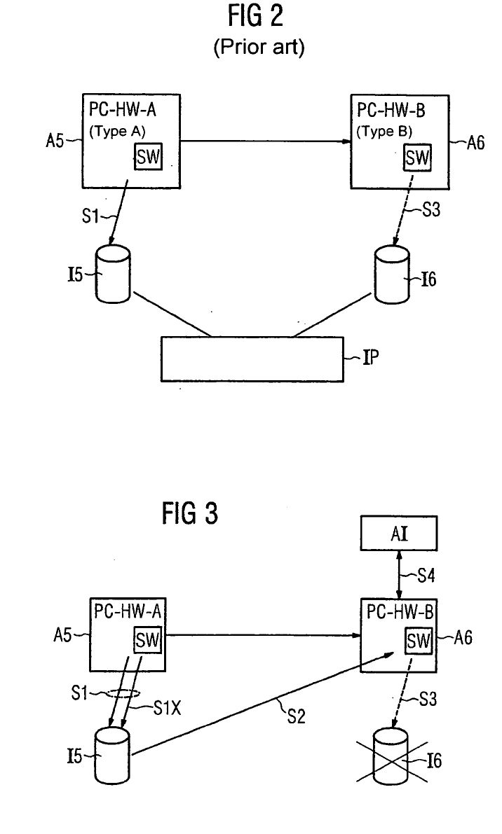

The diagram in FIG. 2 shows an automation device A5 according to the prior art which features PC-based hardware PC-HW-A of a type A. Software SW is installed on this automation device A5. The software SW is for example runtime software, application software Simotion®, Protool® etc. In a step S1 an image 15 of this software is created as a binary image. This image 15 is stored for example at a customer or a user of the automation device A5. The latter thus establishes a backup of the software that can be executed on the automation device A5.

The image 15 is not transmitted to an automation device A6 with changed PC-based hardware PC-HW-B of the type B or able to be executed there, since this features at least one new hardware component compared to automation device A5 which involves hardware-dependent software. The differences, especially a new hardware component, a new driver or a new Interface between the automation devices A5 and A6, mean that a new image 16 is to be created and that this is to be an image of the newly installed software SW for the automation device A6. The different images 15 and 16 of the automation devices A5, A6 with different types of hardware can be stored in an image pool IP for example.

The diagram shown in FIG. 3, like that shown in FIG. 2, has two automation devices A5 and A6. An image 15 can be established by automation device A5 in step S1, with the establishment of the image 15 now, in accordance with the invention, also creating a hardware identifier, i.e. information about the configuration of the hardware which is present as part of the software SW. The additional information of the configuration of the hardware of the automation device A5 is indicated in the Figure by the additional arrow S1X. In a step S2 the image 15 is able to be transmitted to the automation device A6. Furthermore the automation device A6 is also provided with adaptation information A1 with delta information which relates to the difference between type A and type B of the hardware of the automation devices A5 and A6. This adaptation information is given in a step S4 to the automation device A6, with a reconciliation of the hardware HW of type A to type B being able to be performed in this step. The software SW is subsequently also executable on the automation device A6.

The creation of a new image 16 in a step S3 can be executed as an option, however it is no longer absolutely necessary for securing and retaining executable software for the automation device A6.

This type of concept of adaptation of software, especially for upgrading of hardware components can also be applied to software upgrades.

1.-11. (canceled)

12. A method of adapting hardware-dependent software, comprising:
storing within the hardware-dependent software a configuration of a hardware on which the hardware-dependent software can be executed;
detecting an actual configuration of an automation device during runtime of the hardware-dependent software on the automation device;
comparing the stored configuration to the actual configuration; and
adapting the hardware-dependent software using adaptation information if the stored configuration is different from the actual configuration such that the hardware-dependent software is adapted to be executed on the automation device.

13. The method in accordance with claim 12, wherein the hardware-dependent software is a binary image executable on an automation device hardware.

14. The method in accordance with claim 12, further comprising storing the actual configuration within the hardware-dependent software.

15. The method in accordance with claim 12, further comprising generating a request for obtaining the adaptation information by the hardware-dependent software, wherein the hardware-dependent software is adapted upon receipt of the adaptation information.

16. The method in accordance with claim 15, wherein the request is generated after comparing the stored configuration to the actual configuration.

17. The method in accordance with claim 15, wherein the hardware-dependent software is configured to execute its adaptation upon receipt of the adaptation information.

18. The method in accordance with claim 12, wherein the hardware-dependent software is configured to automatically search for the adaptation information on a data medium.

19. The method in accordance with claim 12, wherein the hardware-dependent software is a binary image, the configuration relates to a first automation device, and the actual configuration relates to a second automation device.

20. The method in accordance with claim 12, wherein static data or dynamic data are transmitted from a first automation device to a second automation device using the hardware-dependent software.

21. An automation device, comprising a data memory having a hardware-dependent software, the software configured to:
store within the hardware-dependent software a configuration of a target automation device on which the hardware-dependent software can be executed;
detect an actual configuration of the automation device during runtime of the hardware-dependent software on the automation device;
compare the stored configuration to the actual configuration; and
adapt the hardware-dependent software using adaptation information if the stored configuration is different from the actual configuration such that the hardware-dependent software is adapted to be executed on the automation device.

22. The automation device in accordance with claim 21, wherein the hardware-dependent software or the adaptation information are stored on a removable data medium.

23. The automation device in accordance with claim 21, further comprising a communication device, wherein the hardware-dependent software or the adaptation information are transmitted to the automation device via the communication device.

24. The automation device in accordance with claim 22, wherein the removable data medium is a data medium chosen from the group consisting of a floppy dis c, a memory card and a memory stick.

25. The automation device in accordance with claim 21, wherein the automation device is configured to control a machine tool, a production machine or an automated handling machine.

26. The automation device in accordance with claim 21, wherein the automation device is implemented on a Personal Computer.
